(19) United States
(12) Patent Application Publication
(10) Pub. No.: US 2008/0265555 A1
(43) Pub. Date: Oct. 30, 2008

(54) Reversible Belt Tensioner

(75) Inventors: Karl-Heinz Baumann, Bondorf (DE); Thomas Blaas, Senden (DE); Michael Fehring, Neuhausen (DE); Rainer Justen, Altdorf (DE); Markus Scholz, Waldenbuch (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG

(21) Appl. No.: 12/093,752

(22) PCT Filed: Nov. 11, 2006
(86) PCT No.: PCT/EP2006/010833

§ 371 Date: Jul. 11, 2008

(30) Foreign Application Priority Data
Nov. 15, 2005 (DE) 10 2005 054 841.5

(51) Int. Cl. B60R 22/46

(52) U.S. Cl. 280/806; 280/801.1; 242/384

(57) ABSTRACT

A belt tensioner for a safety-belt restraint system in a vehicle, which can be triggered in the event of a collision or the threat of a collision, includes a device for tensioning a safety belt that is restraining an occupant, by displacing part of the safety-belt restraint system. The belt tensioner has a drive for the displacing the part, which drive comprises a repeatedly chargeable spring-energy store, as well as a spring-energy store charging device for repeatably charging of the spring-energy store once it has been discharged. The spring-energy store charging device transmits to the spring-energy store for the purpose of charging it, a tensile force that is applied to the safety belt to unwind it from a belt winding device in the course of a fastening operation by the occupant.

This application is a national stage of International Application No. PCT/EP2006/010833, filed Nov. 11, 2006, which claims priority under 35 U.S.C. §119 to German Patent Application No. 10 2005 054 841.5, filed Nov. 15, 2005, the entire disclosure of which is herein expressly incorporated by reference.

The invention relates to a belt tensioner for a vehicle safety-belt restraint system, and to a method for charging a spring-energy store of a belt tensioner.

### BACKGROUND OF THE INVENTION

Safety-belt restraint systems for vehicles which have a belt winding device for automatically winding up the loose belt onto a belt winding roller are known. The automatic winding process means that the positioned safety belt bears loosely against the body of an occupant and when the safety belt is not in use, it is wound on the belt winding roller. The unwinding of the safety belt from the belt winding roller takes place counter to a torque applied by a restoring spring.

To increase the protective effect of the safety-belt restraint system, it is known to provide it with a belt tensioner, which, in the event of a collision of the vehicle, withdraws the belt slack from the safety belt in order to shorten it and/or in order to draw an occupant toward the back rest of the vehicle seat into a position with a reduced risk of injury.

A belt tensioner of this type is disclosed, for example, in German patent document DE 41 06 393 A1 which has a drive for displacing part of the safety belt system. This part can be, for example, the safety belt itself or a belt lock. The drive is formed by at least one bending helical spring, which has a limb that acts directly on the moving part. The bending helical spring is held in the tensioned state (spring-energy store charged) by a holding mechanism. For triggering purposes (i.e., to release the spring force for the purpose of belt tensioning), gunpowder is ignited, and its pressure wave destroys a holding element of the holding mechanism. As a result, the spring limb can be displaced, thereby deflecting the safety belt transversely with respect to its normal path out of the belt winding device and forms a loop. The drive (i.e., the bending helical spring) is not required after use, so it can be tensioned/charged again. However, because the destruction of the holding element, the vehicle occupant cannot charge the drive, which necessitates a visit to a workshop.

In addition, reversible belt tensioners are known which can be triggered a plurality of times, even in quick succession. Such reversible belt tensioners have, for example, as the reversing drive an electric motor which acts permanently or via a coupling on the belt spool. Another reversible belt tensioner is driven by compressed air from a pressure accumulator, which can be filled again during driving operation. Furthermore, a reversible belt tensioner is known which is driven by a tensioned spring, it being possible for the spring to be tensioned again during driving operation by means of an electric motor. As a result of the high amount of force of the spring, the electric motor used for reversing purposes needs to have a correspondingly high power and is therefore expensive and in addition has a high space requirement.

Such reversible belt tensioners make it possible to tension the safety belt with a predeterminable intensity, predeterminable speed and predeterminable duration. In particular, the fact that it is possible for the reversible belt tensioner to be triggered a plurality of times makes preventative triggering thereof possible. Preventative triggering means that the belt tensioner is triggered in safety-critical driving situations, which are determined, for example, by driving dynamics sensors or vehicle environment sensors or which have been identified by means of the evaluation of the brake pedal actuation, the steering angle or observation by a driver, and/or in the event of the threat of a collision. A reversible belt tensioner can also be used, in addition to preventative triggering, for haptic warning of the driver in safety-critical situations.

Given preventative triggering of the belt tensioner which can take place prior to a collision being detected or in the event of triggering of the belt tensioner for warning purposes, it is desirable for the belt to be released after the tensioning has taken place (after the end of a hazardous situation and when normal driving operation has been ensured), and for the belt to rest loosely and comfortably against the occupant again. An ensured normal driving operation is present if the evaluation of the situation by a control device or a hazard calculator does not show that a safety-critical situation is present or if the necessary condition for the triggering of the belt tensioner is no longer met. Such a condition may be the presence or the absence of a specific signal on a data bus or a data line.

A belt tensioner with a comfort function for safety-belt restraint systems in vehicles is known, for example, from German patent document DE 38 38 175 C1. It has a wind-up spring that acts between a part fixed to the housing and the belt spool accommodating the belt band, a ratchet wheel mounted rotatably between the roll-up spring and the belt spool, to which one end of the roll-up spring is drive-connected, and a comfort spring that is weaker than the roll-up spring and is active between the ratchet wheel and the belt spool. The ratchet wheel interacts with a ratchet, which blocks or enables rotary movement of the ratchet wheel as a function of a control signal. The roll-up spring and the comfort spring are therefore positioned functionally in a row between the housing of the belt winding device and the belt spool as long as the safety belt is not positioned. Because the roll-up spring is stronger, the comfort spring is tensioned completely (tightened to the full extent), so that the force produced by the roll-up spring acts unprevented on the belt spool. Positioning of the safety belt can be fixed, for example, by a belt lock switch, which is actuated by the plug-in tongue.

As soon as the safety belt is positioned, the ratchet wheel is held fixed against rotation, for example by means of an electromagnet, which guides the ratchet into the toothed formation of the ratchet wheel. As a result, only the more weakly dimensioned comfort spring is active between the housing and the belt spool, and the belt tensioning is correspondingly reduced in order to increase the positioning comfort. A comparable system with an electromagnet as the electrically drivable switching element for a comfort system which can be switched between two operating states is also known from U.S. Pat. No. 4,564,153.

International patent document WO 03/051687 discloses a further belt winding device with a comfort system comprising two springs which are arranged next to one another, have different spring characteristics, and can be connected in series by an electrically drivable switching element. The switching element is formed by an electric motor, which otherwise (i.e., in the event of the threat of a collision) drives a tensioning device acting on the belt shaft.

### SUMMARY OF THE INVENTION

One object of the invention is to provide a belt tensioner of the type mentioned at the outset which is reversible, preferably during driving operation, and in addition has a cost-effective design.

A further object of the invention is to provide a method for charging the spring-energy store of the reversible belt tensioner which can be carried out easily by the occupant, preferably without any tools, after the belt tensioner has been triggered.

This and other objects and advantages are achieved by the belt tensioner apparatus and method according to a spring-energy store charging device for repeatedly charging the spring-energy store once it has been discharged. The spring-energy store charging device charges the spring-energy store by transmitting to it a tensile force that is applied to the safety belt (which has previously been wound up by a belt winding device), to unwind it in the course of fastening the safety belt, by a vehicle occupant. Manual reversing of the belt tensioner therefore takes place with one or more subsequent fastening operations (in particular immediately, and preferably by a single fastening operation), as a result of the safety belt's being brought back into its rest position/out-of-use position by a belt winding device, and thereafter being fastened once again by the occupant. One advantage of the belt tensioner according to the invention (in comparison with known reversible belt tensioners) is that it is considerably more cost-effective, and can be configured in a space-saving manner.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic depiction of a belt tensioner system according to the invention;

FIG. 2 is a flow chart that shows the steps of the method according to the invention, for charging the spring-energy store device in FIG. 1.

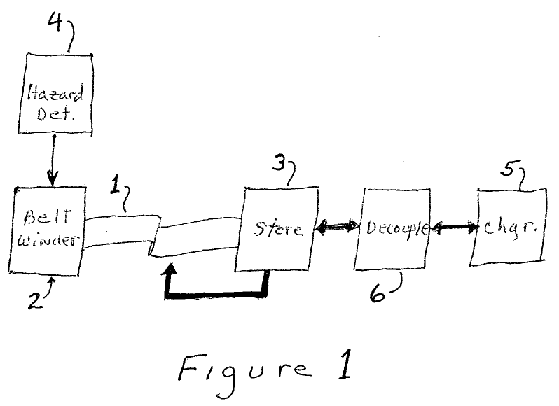

### DETAILED DESCRIPTION OF THE DRAWINGS FIG. 1 is a schematic illustration that shows the components of a belt tensioning system according to the invention, which includes a safety belt 1, that can be wound onto a belt winder 2 when it is not in use. A spring-energy store 3 for applying tension to the safety belt 1 in response to an input from a hazard detection device 4 is coupled to a spring-energy store charging device 5.

In a preferred embodiment of the belt tensioner according to the invention, a decoupling apparatus 6 (which decouples the spring-energy store from the spring-energy store charging apparatus when the spring-energy store has been charged) is provided between the spring-energy store charging device 5 and the spring-energy store 3. This ensures that the occupant does not have to apply increased withdrawal force to withdraw/unwind the safety belt 1 from the belt winding device 2 when positioning the safety belt during a fastening operation in which the spring-energy store is already charged (i.e., when the belt tensioner is in the functionally ready state).

According to a feature of the belt tensioner according to the invention, the spring-energy store charging device 3 may comprise a transmission gear, which predetermines the tensile force to be applied by the occupant to the safety belt and/or the belt withdrawal path in the event of a fastening operation for the purpose of charging the spring-energy store 3. By selecting a corresponding transmission ratio of the transmission gear, a tensile force which is required for tensioning the spring-energy store and is to be applied by the occupant, can be set or predetermined. This represents, for example, a compromise of increased withdrawal force when reversing and tensioning/charging of the spring-energy store 3 after a discharging process with as few withdrawal operations as possible.

In one embodiment of the belt tensioner, the spring-energy store charging device is designed so that the spring-energy store 3 is charged again properly for repeated use with only a single withdrawal/fastening operation in which the safety belt 1 is withdrawn from the rest position/out-of-use position such an extent that an occupant located on the vehicle seat can position it and insert a belt tongue located on the safety belt into a belt lock fixed on the vehicle seat or on the vehicle support structure.

In accordance with another embodiment of the spring-energy store charging device, the latter is designed such that a plurality of withdrawal or partial withdrawal operations are required to charge the spring-energy store.

In a preferred embodiment of the belt tensioner according to the invention, the decoupling apparatus 6 is designed such that, after triggering of the belt tensioner, the spring-energy store 3 is decoupled from the safety belt 1 in such a way that the safety belt system is powerless or approximately powerless until the safety belt 1 has been completely wound up again by means of the belt tensioner.

Particularly preferred is an exemplary embodiment of the belt tensioner in which the spring-energy store 3 can be triggered by a hazard early detection system 4, such as described, for example, in German patent document DE 101 21 386 C1. This results in particular in a method for driving a reversible occupant protection device in a motor vehicle having a driving state sensor system that detects driving state data and a reversible occupant protection system, which can be triggered prior to the collision time and as a result brought into the active position. Such a system is also referred to as PRESAFE™ system. In this case, the driving state data are monitored for a state of “emergency braking”, and when the same is detected, the occupant protection means is driven. In addition, a state of “oversteering” and/or “understeering” is determined by the data processing device. If the state of “emergency braking” and/or the state of “oversteering” and/or the state of “understeering” is detected by the data processing device, the reversible occupant protection system is driven. Once the critical driving state has been eliminated, the driven occupant protection system is deactivated.

The hazard early detection system 4 which is used in connection with the belt tensioner according to the invention, and is suitable in particular for preventative belt tensioning, preferably evaluates the data from an object identification, in particular by means of an environment sensor system, driving state detection or driver observation. Triggering of the belt tensioner prior to a collision (and/or during the threat of a collision or at the moment of the collision) is therefore possible.

Also preferred is an embodiment of the belt tensioner in which an electric motor produces an additional force for assisting an occupant's manual charging of the spring-energy store by causing said spring-energy store 3 to move the safety belt out of its rest position during a fastening operation. As a result, the belt withdrawal force that must be applied manually during the fastening operation for the purpose of charging the spring-energy store, can be kept low, increasing operational convenience. This combination of manual belt withdrawal force auxiliary motor-driven assistance is preferable to known reversible belt tensioners in which the tensioning takes place exclusively by means of a high-power electric motor, because only low electrical powers need be provided by the on-board electrical system of the vehicle. The electric motor used for this purpose is also considerably smaller and more cost-effective than the electric motors used in reversible belt tensioners which are tensioned by means of an electric motor.

In accordance with a first variant embodiment of the belt tensioner, the part which is moved for the purpose of tensioning the belt is the safety belt 1. A tensile force is applied thereto by means of the belt tensioner, for example by means of a loop formation. In accordance with a second variant embodiment, the part of the safety belt-restraint system which is to be moved for the purpose of tensioning is the belt lock, which is either fixed on the vehicle seat or on the vehicle support structure. In the case of a safety belt which is positioned properly, a belt tongue arranged thereon is inserted into the belt lock and fixed by means of suitable holding means. As a result of a displacement of the belt lock, the tensile force is transmitted to the safety belt via the belt tongue held by means of said belt lock. In the case of a third variant embodiment, the displaceable part is a belt band fixing provided on the chassis or on the seat.

Furthermore, in a preferred embodiment, of the invention, the belt tensioner is a modular unit and can be coupled to the belt winding device. For example, the belt tensioner can be formed by a cassette accommodating the spring-energy store 3. This configuration provides the option of adapting the belt tensioner to existing belt winding devices 2 without substantial modification to existing safety-belt restraint systems.

In another, particularly preferred exemplary embodiment, the belt tensioner and the belt winding device are in the form of a modular unit, which is particularly space-saving. Such a belt winding and tensioning unit can be based, for example, on known belt winding devices with a comfort function which have two switchable spring-energy stores in the form of in each case at least one restoring spring, by means of which different levels of restoring forces can be generated. This system is switched, for example, by a belt lock switch in order to enhance wearing comfort when the belt is positioned.

Furthermore, an exemplary embodiment of the belt tensioner is preferred in which latching means for securing the charged state of the spring-energy store 3 are provided. The latching means can be, for example, a pivotable latching ratchet, which, by means of a drivable triggering device, can be displaced (in particular pivoted) between a blocking/latching position (in which the spring-energy store is held in the charged/tensioned state), and a release position (in which the spring-energy store can release its stored spring energy and can transfer it to that part of the safety-belt restraint system which is to be moved). In accordance with a further development it is provided that the latching means can be triggered by the hazard early detection system.

The subject matter of the invention also relates to a safety-belt restraint system for vehicles, in particular motor vehicles, which is provided with at least one belt tensioner having the features disclosed herein.

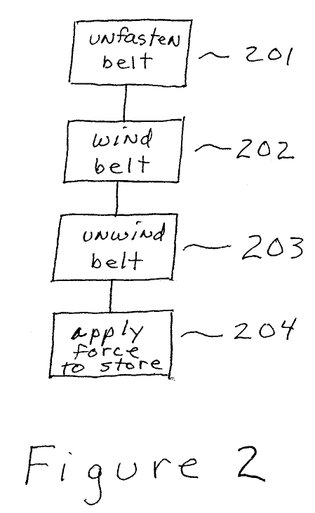

The invention further provides a method for manual reversing/charging of the spring-energy store by a fastening operation which follows triggering of the belt tensioner. As shown in FIG. 2, the charging operation is performed by the vehicle occupant first unfastening himself (step 201) and the safety belt band being moved back into its out-of-use position by winding it on the belt winding device (step 202). When the safety belt band is unwound again from the belt winding device (step 203), force-effective coupling between the safety belt band and the spring-energy store is produced in such a way that the tensile force applied to the safety belt band when the safety belt is withdrawn from the belt winding device is used to charge the spring-energy store (step 204), which is triggered in the event of a collision or in the event of a threat of a collision and is thereby discharged.

In the text which follows, the design, the operation and the advantages of the belt tensioner according to the invention will be explained with reference to an exemplary embodiment. The manually reversible belt tensioner has, for the purpose of removing slack in the safety belt in the event of a crash or the threat of a crash, for example in a critical driving situation, a spring-energy store. For this purpose, a spiral spring can be coupled to the belt winding device in a cassette, for example. The attachment of the spiral spring to the belt winding device, which generally for its part has at least one belt restoring spring for automatic winding of an necessary belt band excess, is in this case such that the spiral spring can be tensioned in the event of each fastening operation in which the safety belt is withdrawn from the belt winding device and is therefore brought automatically into an operation-ready, charged state. The tensioned spring is latched by means of latching means and needs to be tensioned again only when it has been detensioned, for example, by a trigger signal, which results in cancelling of the spring latching.

If a transmission gear, as described above, is provided, by selecting a corresponding transmission ratio when charging the spring, the charging path which must be covered by the part to be displaced of the safety-belt restraint system for the desired tensioning of the safety belt or the charging force to be applied by the occupant can be predetermined correspondingly in design terms. It is advantageous here that, even in the case of a single fastening operation by smaller occupants, sufficient spring energy can be stored in the spring-energy store. The tensioned spring is kept in the tensioned state and can then be triggered, for example, by a PRE-SAFE™ signal. During detensioning of the spring, the belt tensioner removes belt slack from the safety belt system.

After triggering, the spring-energy store can be decoupled in terms of force from the safety belt, so that ultimately only the force which is conventionally produced by means of a motive spring for winding up the belt band still acts on the safety belt, at least until the belt winding device has wound up the safety belt completely again. Manual reversal of the belt tensioner can now take place with the next fastening operation, or can also take place immediately by a single unfastening operation, or by the safety belt being brought back into its rest position and a renewed unfastening operation.

The belt tensioner according to the invention has the advantage over known pyrotechnical belt fasteners that it can be reversed in a simple manner by the occupant himself and has a more cost-effective design in comparison with belt fasteners driven by electric motors.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-14. (canceled)

15. A belt tensioner for a vehicle safety-belt restraint system that can be triggered in response to a collision or a threat of a collision, to apply tension to a safety belt for restraining a vehicle occupant, by displacing a part of the safety-belt restraint system, said belt tensioner comprising:
a drive which comprises a repeatedly chargeable spring-energy store for displacing said part;
a spring-energy store charging device for repeatably charging the spring-energy store once it has been discharged;
wherein, spring-energy store charging device charges the spring-energy store by transmitting to it a tensile force that is applied to the safety belt by a vehicle occupant to unwind the safety belt, which is wound up by a belt winding device, in the course of fastening the safety belt.

16. A belt tensioner as claimed in claim 15, further comprising a decoupling apparatus, which decouples the spring-energy store from the spring-energy store charging apparatus when the spring-energy store has been charged, and which is disposed between the spring-energy store charging device and the spring-energy store.

17. The belt tensioner as claimed in claim 15, wherein the spring-energy store charging device comprises a transmission gear, which predetermines the tensile force to be applied by the occupant to the safety belt or to the belt withdrawal path in a fastening operation, for the purpose of charging the spring-energy store.

18. The belt tensioner as claimed in claim 15, wherein the spring-energy store can be triggered by a hazard early detection system.

19. The belt tensioner as claimed in claim 15, further comprising an electric motor for producing an additional force to assist a manual charging of the spring-energy store by the occupant, by said spring-energy store moving the safety belt out of its rest position during a fastening operation.

20. The belt tensioner as claimed in claim 15, wherein part of the belt arrangement is a belt section or a belt lock for connecting a belt section to the vehicle or a belt band fixing.

21. The belt tensioner as claimed in claim 15, wherein, the belt tensioner comprises a modular unit and can be coupled to the belt winding device.

22. The belt tensioner as claimed in claim 15, wherein the belt tensioner and the belt winding device collectively comprise a modular unit.

23. The belt tensioner as claimed in claim 15, further comprising latching means for securing the charged state of the spring-energy store.

24. The belt tensioner as claimed in claim 23, wherein the latching means can be triggered by means of a hazard early detection system.

25. A safety-belt restraint system for a vehicle comprising a belt tensioner as claimed in claim 15.

26. A method for charging a spring-energy store of a belt tensioner that can be triggered in response to a collision or a threat of a collision to apply tension to a safety belt for restraining a vehicle occupant by displacing a part of the safety belt restraining system, said belt tensioner including a drive that comprises a repeatedly chargeable spring-energy store for displacing said part, and a spring-energy store charging device for repeatably charging the spring-energy store after it has been discharged; said method comprising:
a vehicle occupant unfastening the safety belt from a restraining deployment, and causing the safety belt to be moved back into an out-of-use position by being wound up by a belt winding device;
said vehicle occupant unwinding said safety belt from the belt winding device; and
charging the spring-energy store by transmitting to it a tensile force that is applied to said safety belt by said vehicle occupant in said unwinding step.

27. The method as claimed in claim 26, wherein a single fastening operation is sufficient for completely charging the spring-energy store.

28. The method as claimed in claim 26, wherein a withdrawal path of the safety belt band from the belt winding device for complete charging of the spring-energy store is greater than a withdrawal path in the event of a single fastening operation, whereby a plurality of withdrawal operations or partial-withdrawal operations can be implemented consecutively.
